(19) United States
(12) Patent Application Publication
(10) Pub. No.: US 2007/0294174 A1
(43) Pub. Date: Dec. 20, 2007

(54) Electronic Greeting Recruitment Architecture

(75) Inventor: Paul Thelen, Seattle, WA (US)

Correspondence Address: LEE & HAYES, PLLC, 421 W. RIVERSIDE AVE, STE 500, SPOKANE, WA, 99201, US

(73) Assignee: Big Fish Games, Inc., Seattle, WA (US)

(21) Appl. No.: 11/421,397

(22) Filed: May 31, 2006

(51) Int. Cl. H04L 9/00

(52) U.S. Cl. 705/52

(57) ABSTRACT

A network service recruitment architecture for marketing casual computer games, electronic greeting cards, or other similar electronic products delivered over a network is described. The architecture enables consumers to recruit other potential consumers to purchase or use such products delivered over the network. The recruiters are allowed to join a network of recruiters free of any start up fees or ongoing costs. When the recruiter successfully recruits a new consumer to purchase or play a game or send an electronic greeting card, a portion of any revenue generated by the consumer's participation is distributed to the recruiter.

### BACKGROUND

The number and variety of services provided over a network, such as the Internet, are continually increasing. Among the products being offered and delivered via network services over the Internet are casual computer games, electronic greeting cards (commonly referred to as “e-greetings”), and other electronic products.

Casual computer games are typically configured as relatively small computer games (e.g., less than fifty megabytes) that may be played or easily downloaded over the Internet. A user may employ a browser to navigate to a website and play such casual games as Mahjong, word games, card games, board games, action games, mystery games, arcade games, puzzle games, and so on. Casual games are frequently targeted to mature gamers, which is one of the fastest growing segments of Internet users.

As another example of electronic products, a user may visit a website to purchase and send an electronic greeting card to another person over the Internet. The electronic greeting card may be configured in a variety of ways. It may be a standard greeting with stock pictures and text similar to a paper-based greeting card. Alternatively, the greeting card may be customizable to include images and text provided by the users (e.g., family photos and personal greeting). Furthermore, electronic greeting cards may include animation elements, multimedia presentations (e.g., graphics, text, video, and/or audio), and so on.

Because interaction with and purchase of such electronic products is performed over the Internet, consumers are not typically exposed to a “tangible” product. In contrast, when a consumer purchases a physical greeting card or computer game, the consumer visits a bricks-and-mortar store and looks through the selection of products on the shelves. A computer game is stored on a computer-readable medium (e.g., a CD-ROM) and displayed in colorful shrink-wrapped packaging. Greeting cards are arranged neatly in rows for consumers to pick up and read. The consumer can physically handle the game or greeting card, view advertising or packaging designed to market the product, or read more information about the product if so desired. However, when such products are made available exclusively over the Internet, users may not be as readily exposed to those products as compared to their shopping experiences in stores. Users are not able hold the electronic items or see packaging materials used to display and market the product. Therefore, marketing such products presents a challenge.

Accordingly, there is a need for improved techniques to market web-based electronic products delivered over the Internet, such as casual computer games and electronic greeting cards.

### SUMMARY

A network service recruitment architecture for marketing casual computer games, electronic greeting cards, or other similar electronic products delivered over a network is described. The architecture enables consumers to recruit other potential consumers to purchase or use such products delivered over the network (e.g., Internet). The recruiters are permitted to join a network of recruiters free of any start up costs or ongoing fees. When the recruiter successfully recruits a new consumer to purchase or play a game or send an electronic greeting card, a portion of any revenue generated by the consumer's participation is distributed to the recruiter. Moreover, a portion of any revenue generated by that consumer's purchase of future games or electronic greeting cards is also distributed to the recruiter.

Subsequently, the new consumer may also become a recruiter free of any start up costs or ongoing fees. When that consumer (now a second recruiter) successfully recruits another or third consumer to purchase a computer game or send an electronic greeting card, a portion of the revenue generated by the third consumer's participating is distributed to the original recruiter and the consumer (or second recruiter). This can continue for multiple levels of recruiters, where many recruiters receive a share in the revenue. In one implementation, the share portion for a recruiter diminishes in relationship to the number of levels removed from the purchasing consumer.

The network service recruitment architecture may also be configured to provide utilities to assist in the recruitment of potential consumers. For example, the utilities may provide preconfigured emails to be sent by a recruiter to other users. A recruiter, for instance, may specify recruits to receive preconfigured emails and manage the status of those emails (e.g., which were sent and to whom) through interaction with the utility. In another example, a utility may be provided to create links, such that a recruiter may copy a link into a web log or other web page to provide a link to games or electronic greetings cards. The links may also be included within preconfigured advertisements for inclusion on web pages that are modifiable by the recruiter. In a farther example, a utility is provided to create a customizable web page, such as a web page having links to games that are favorites of the recruiter, tips and other commentary relating to the games, and so on. The recruiter may then direct recruits to this page to increase a likelihood that the recruit will play games and thus share in revenue. A variety of other utilities are also contemplated.

Other implementations are also contemplated without departing from the spirit and scope of the architecture and methodologies discussed herein.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 is an illustration of an exemplary environment in which techniques for marketing network services, such as casual games and greetings, to other consumers may be implemented.

FIG. 2 is an illustration of a network service system and one of the client devices of FIG. 1 in greater detail.

FIG. 3 is a flow diagram depicting a procedure in an exemplary implementation in which revenue collected from recruits to play games is shared with a recruiter.

FIG. 4 is an illustration of an exemplary implementation showing a hierarchy having a plurality of levels arranged according to a recruiter/recruit relationship.

FIG. 5 is a flow diagram depicting a procedure in an exemplary implementation in which a consumer interacts with a utility provided by a network service system to recruit other consumers.

FIG. 6 is an illustration of a user interface of FIG. 2 showing a login screen according to the procedure of FIG. 5 that includes a description of how revenue is to be shared as well as step-by-step instructions for how to register as a recruiter.

FIG. 7 is an illustration of a user interface of FIG. 2 configured to create a list of recruits according to the procedure of FIG. 5.

FIG. 8 is an illustration of a user interface of FIG. 2 in which may specify email addresses of other users that are being recruited according to the procedure of FIG. 5.

FIG. 9 is an illustration of a user interface of FIG. 2 in which a user may select from different utilities that may be used to recruit other users according to the procedure of FIG. 5.

FIG. 10 is an illustration of a user interface of FIG. 2 configured to create a preconfigured email to send to another consumer according to the procedure of FIG. 5.

FIG. 11 is an illustration of a user interface of FIG. 2 configured to create a personalized webpage according to the procedure of FIG. 5.

FIG. 12 is an illustration of a user interface of FIG. 2 configured to create links according to the procedure of FIG. 5.

FIG. 13 is an illustration of a user interface of FIG. 2 configured to create advertisements according to the procedure of FIG. 5.

FIG. 14 is an illustration of a user interface of FIG. 2 configured to monitor revenue according to the procedure of FIG. 5.

### DETAILED DESCRIPTION

Overview

A network service recruitment architecture for marketing casual computer games or electronic greeting cards delivered over a network (e.g., Internet) enables consumers to recruit other potential consumers to purchase or use such electronic products. Because casual computer games and electronic greeting cards are usually made available exclusively over the Internet, users are not exposed to a tangible product in stores, or distinctive packaging, or print advertisement for such products. Thus, marketing such electronic products poses a challenge. While such products can be marketed via online advertisements or informal word of mouth, the network service recruitment architecture described herein provides a more effective approach to marketing casual computer games, greeting cards, and other selected electronic products.

The architecture allows consumers to “share” in revenue generated from other consumers that they recruited. For example, a consumer who plays casual games, such as Mahjong or mystery games, provided by an online service for a fee over the Internet might further recruit other prospective consumers to play these games. The consumer may be referred to as a “recruiter” of these other prospective consumers or “recruits”. The recruiter joins or registers with a network of recruiters free of cost (i.e., no start fee, no inventory purchases, no ongoing costs, etc.). The recruiter then begins trying to market, encourage, or otherwise entice other prospective consumers to play the computer games. When one or more of the recruits plays the games, any fees collected from the recruits may be shared with the recruiter. Similar techniques may be utilized to recruit others to send electronic greeting cards to generate revenue, such as through a subscription, fee per transaction, and so on.

The recruited consumer can then join the network of recruiters free of cost and begin trying to recruit other prospective consumers to purchase a computer game or send an electronic greeting card. When this occurs, revenue generated by these new consumers is distributed to the original recruiter and the second recruiter. In this manner, consumers have incentive to market the casual computer games or electronic greeting cards to their friends, family, and acquaintances. Furthermore, once a consumer is designated as a recruit of the recruiter, that recruiter shares in any future revenue generated by the consumer. Thus, if a consumer is successful in building his or her own network of affiliate recruits, that consumer can earn an increasingly significant revenue stream.

In one implementation, the share portion for a recruiter diminishes in relationship to the number of levels removed from the purchasing consumer. As one example, the recruiter may share revenue collected from directly and indirectly recruited consumers according to a function Xⁿ, where “n” denotes a difference in the levels between the recruiter and consumer making the purchase and “X” denotes a predetermined percentage of the revenue to be distributed.

Monetary fee sharing is just one possibility. In some games, for example, tokens are awarded to users when various levels or scores are achieved. Although they carry no real cash value, these tokens may be exchanged for products (e.g., promotional clothing), used to purchase of additional games, used to used purchase prices of games or products, used to redeem electronic enhancements to a game experience (e.g., a visual enhancement to an avatar, such as a gold medal for an online character), and so on. Thus, when a game player earns tokens, additional tokens may be shared with the recruiter of the game player to reward the recruiter and not adversely dilute the player's “winnings”. Thus, a wide variety of different types of revenue may be shared between recruit and recruiter.

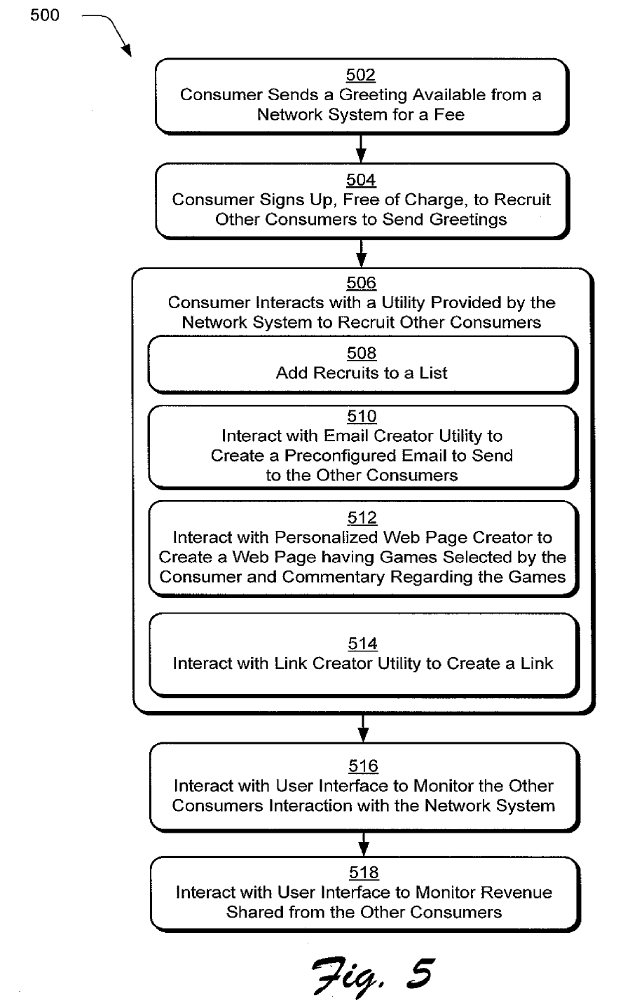

The architecture provides utilities (i.e., tools) that are accessible by the recruiter to support efforts to recruit other consumers of the electronic products. For example, the utility may provide preconfigured emails to be sent to prospective users, preconfigured advertisements, customizable web pages, and so on. Further discussion of an architecture to assist in the recruitment of users may be found in relation FIGS. 5-14.

In the following discussion, an exemplary environment is first described that is operable to perform techniques to market network services such as casual games and electronic greeting cards Exemplary procedures and user interfaces are then described that may be employed in the exemplary environment, as well as in other environments.

Exemplary Environment

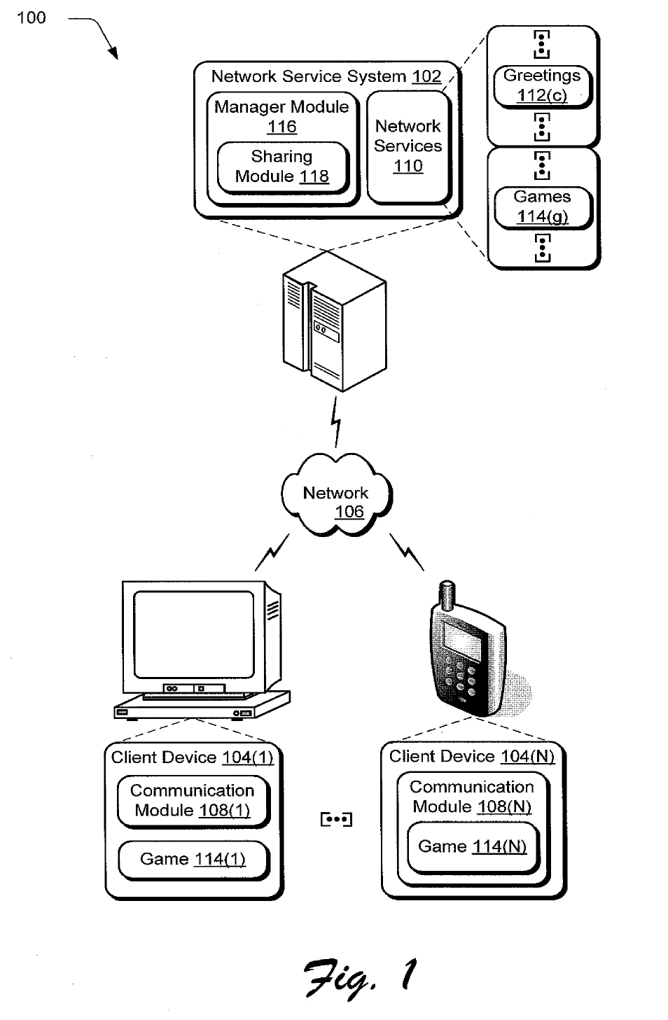

FIG. 1 shows an exemplary architecture 100 in which products such as casual computer games and/or electronic greeting cards provided by an online service can be marketed effectively. The architecture 100 has a network service system 102 (also referred to as a service system 102) communicatively coupled to a plurality of client devices 104(1), . . . , 104(N) via a network 106.

The client devices 104(1)-104(N) may be configured in a variety of ways to access the network 106. For example, one or more of the client devices 104(1)-104(N) may be configured as a computing device, such as a desktop computer (e.g., as illustrated by client device 104(1)), a mobile station, an entertainment appliance, a set-top box communicatively coupled to a display device, a wireless phone (e.g., as illustrated by client device 104(N)), a game console, and so forth. Thus, the client devices 104(1)-104(N) may range from full resource devices with substantial memory and processor resources (e.g., personal computers) to low-resource devices with limited memory and/or processing resources (e.g., a personal digital assistant (PDA)).

The network 106 may assume a wide variety of configurations. For example, the network 106 may include the Internet, a wide area network (WAN), a local area network (LAN), a wireless network, a public telephone network, an intranet, and so on. Further, although a single network 106 is shown, the network 106 may be configured to include multiple networks.

Each of the client devices 104(1)-104(N) is illustrated as having a respective communication module 108(1)-108(N), which is representative of functionality to communicate with the service system 102 over the network 106. For example, the communication modules 108(1)-108(N) may be configured as browsers that are used to display and interact with resources over the network 106 (e.g., “surf the Internet”), such as to receive web pages and so on. In another example, the communication modules 108(1)-108(N) are representative of functionality incorporated within another module (i.e., a smart module) to communicate over the network 106, such as an application program having Internet access capabilities. A variety of other examples are also contemplated.

The service system 102 may be implemented in any number of ways, including as a mainframe computer system, as a standalone server, or as a cluster or farm of servers. The service system 102 hosts network services 110 which may be made available to users over the network 106. In one implementation, the network services are accessible via a website hosted at the network service system 102 or elsewhere.

The network services may be configured in a variety of ways. For example, the network services 110 may support an electronic greeting card service in which consumers may purchase one or more electronic greeting cards 112(c) (where “c” can be any integer from one to “C”) and have the greeting cards 112(c) delivered over the network 106 to one or more of the client devices 104(1)-104N).

In another example, the network services 110 may support an online gaming service in which consumers can access one or more computer games 114(g) (where “g” can be any integer from one to “G”) over the network 106 for a fee using the client devices 104(1)-104(N). In one particular implementation, the computer games are casual computer games, which are commonly configured as relatively small games (e.g., less than fifty megabytes) that may be played over the Internet or easily downloaded to the client devices. The computer games 114(g) may be configured in a variety of ways to provide a wide variety of different gaming themes or genre. Example games 114(g) include Mahjong, word games, card games, board games, action games, arcade games, puzzle games, mystery games, and so on.

A manager module 116 manages access to and provision of the network services 110 to facilitate user interaction with the online services. For example, the manager module 116 may receive a request from one client device 104(1) to interact with a particular one of the games 114(g). The manager module 116 may collect or record a fee resulting from the client device 104(1) interaction with the game 114(g). In this example, the client device 104(1) uses the communication module 108(1) to access the website and download a stand-alone game 114(1) for local execution. In another example, the other illustrated client device 104(N) accesses a browser-based game 114(N) that is executed remotely by the service system 102. Therefore, although the user may interact with the communication module 108(N) to play the game 114(N), execution of the game 114(N) is performed by the service system 102 responsive to input from the client device. A variety of other examples are also contemplated, such as through execution of a game, at least in part, both locally on the client device and remotely by the service system 102 over the network 106.

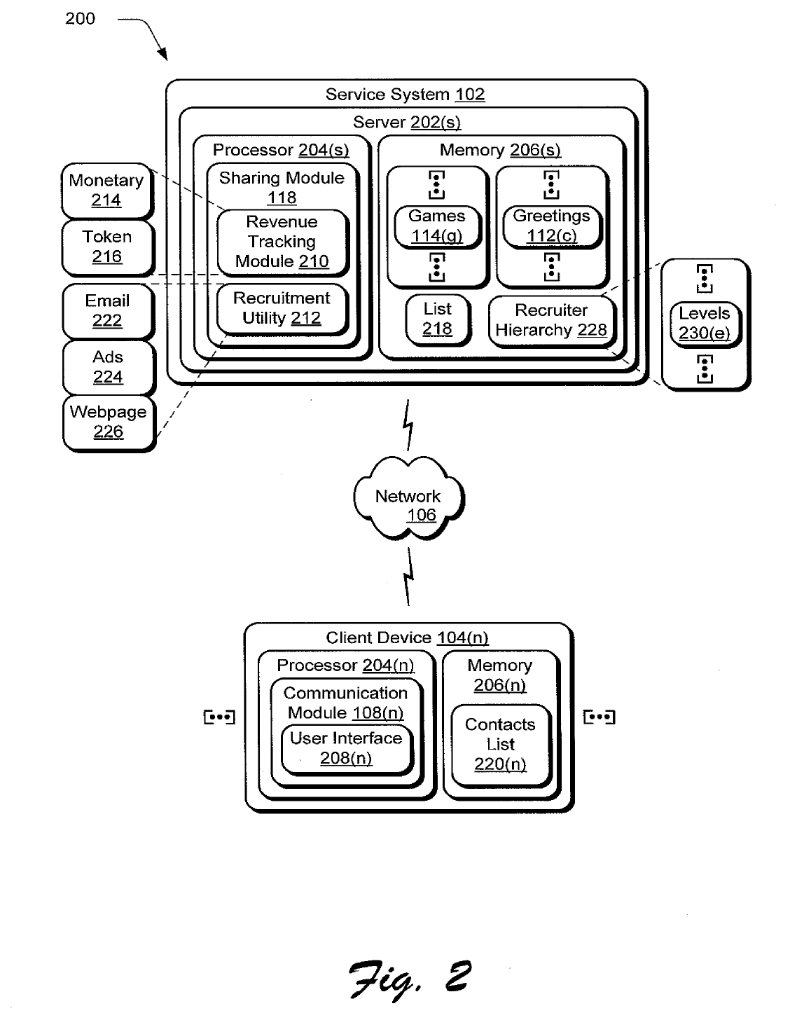

To improve marketing of the greetings 112(c) and games 114(g) to users of the client devices 104(1)-104(N), the manager module 116 is illustrated as including a sharing module 118 which is representative of functionality to share revenue for recruitment of users to purchase electronic greeting cars 112(c) or to play the games 114(g). A user of client device 104(1), for instance, may recruit a user of client device 104(N) to play at least one of the games 114(g) for a fee. Revenue collected from the user of the client device 104(N) to play the games 114(g) may then be distributed by the sharing module 114 with a user of client device 104(1), i.e., the recruiter. Thus a user of client device 104(1) (i.e., the recruiter) “shares” in the revenue collected by the service system 102 from the user of client device 104(N) (i.e., the recruit). A variety of revenue sharing techniques may be employed by the service system 102 through use of the sharing module 118, further discussion of which may be found in relation to FIG. 2.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer-readable memory devices, further discussion of which may be found in relation to the following figure, The features of the marketing techniques described below are platform-independent, meaning that the techniques may be implemented on a variety of commercial computing platforms having a variety of processors.

FIG. 2 illustrates a more detailed, but still exemplary, implementation of the architecture 200 in which certain components of the service system 102 and a representative client device 104(n) are shown. The service system 102 is illustrated as being implemented by a server 202(s). Additionally, the server 202(s) and the client device 104(n) are implemented with respective processors 204(s), 204(n) and respective memories 206(s), 206(n).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computer, may include, but are not limited to, quantum computing, optical computing, mechanical computing (e.g., using nanotechnology), and so forth. Additionally, although a single memory 206(s), 206(n) is shown, respectively, for the server 202(s) and the client device 104(n), a wide variety of types and combinations of memory may be employed, such as random access memory (RAM), hard disk memory, removable medium memory, and other types of computer-readable media.

The client device 104(n) is illustrated as executing the communication module 108(n) on the processor 204(n), which is also storable in memory 206(n). The communication module 108(n) is executable to provide a user interface 208(n) to interact with the service system 102 over the network 106. For example, the user interface 208(n) may display web pages to login to the service 102, play browser-based games executed by the service system 102, send greetings 110(g) to other client devices, download games for execution on the client device 104(n), recruit other users to interact with the service system 102, and so on, further discussion of which may be found below.

The service system is illustrated as executing the sharing module 118 on the processor 204(s) of the server 202(s), although the sharing module 118 is physically stored in memory 206(s). The sharing module 118 includes a revenue tracking module 210 and a recruitment utility 212. The revenue tracking module 210 tracks revenue attributable to users who purchase, play, or otherwise interact with one or more of the network services of the service system 102. For example, the revenue tracking module 210 may track monetary revenue 214 collected on a per-transaction basis (e.g., a fee for each game 114(g) downloaded), a subscription basis (e.g., fee collected for access rights for a particular amount of time), and so on. The revenue tracking module 210 may also track token related revenue 216. For example, the service system 102 may provide tokens to users that play the games 114(g), a number of tokens for a given number of greetings 112(c) sent, and so on. Revenues tracked by the tracking module 210 are distributed to the people who are directly or indirectly responsible for recruiting the users.

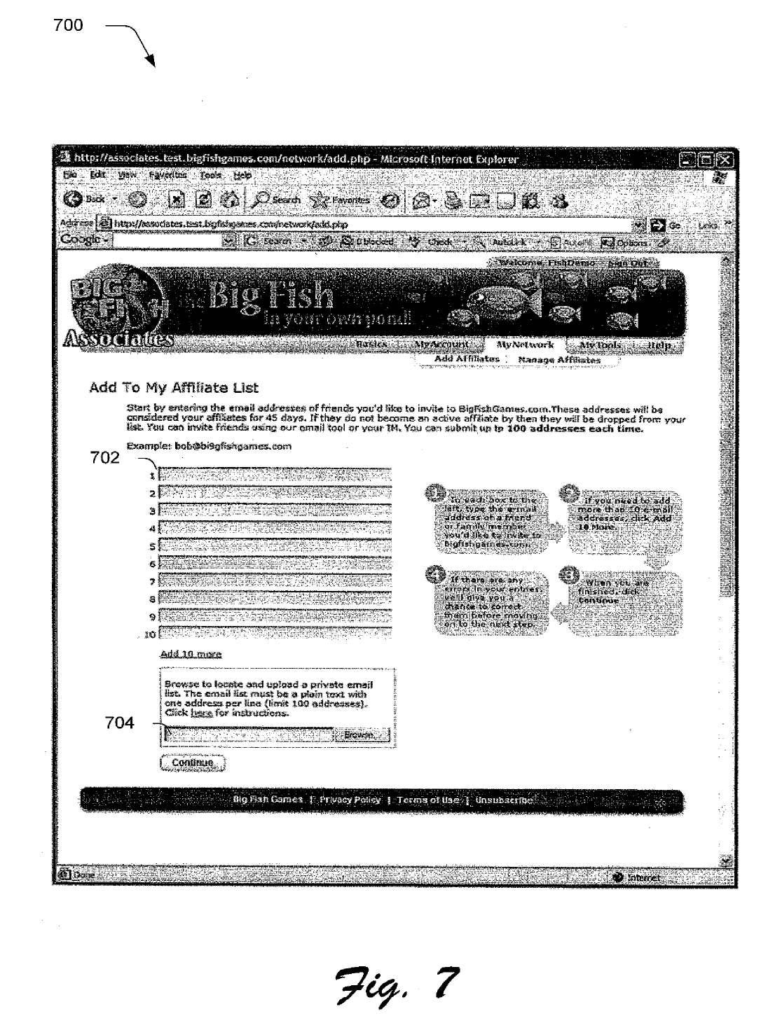

The service system also tracks which users are recruited by whom in order to determine how the revenue will be shared. In one implementation, users identified as being recruited by a particular recruiter are designated as part of the recruiter's network indefinitely. In other implementations, users who don't participate for extended periods of time may be dropped from the recruiter's network. To identify or claim potential recruits, the recruiter may specify a list 218 of other users that are being recruited. When the recruits interact with network services of the service system 102, those recruits are identified as belonging to or being associated with the recruiter and any fees collected from the recruits in the list 218 are shared with the recruiter. The list 218 may be formed in a variety of ways, such as through manual entry of users in an interface, automatic download of a contacts list 220(n) stored in memory 206(n) of the client device 104(n), and so on, further discussion of which may be found in relation to FIG. 7.

The recruitment utility 212 represents one or more tools made available to assist recruiters when recruiting or otherwise enticing users to interact with network services (e.g., playing games 114(g) or sending greetings 112(c)). In this illustration, the recruitment utility 212 provides three types of support: email 222, advertisement 224, and webpage 226.

More specifically, the recruitment utility 212 may provide preconfigured emails 222 that recruiters may send to prospective users. The recruiter can specify an email address and have the email sent with little effort. The recruitment utility 212 may further provide advertisements (ads) 224 for inclusion on web pages that are modifiable by the recruiter. For instance, the recruiter may configure a web log (blog) to include a discussion of games or greetings found on the service system 102. The recruiter may also include the ads 224 such that a user may select (e.g., “click”) the ads 224 to navigate over the network 106 to the service system 102.

In yet another example, the recruitment utility 212 includes a customizable webpage 226 that is configurable by the recruiter to recruit other users. For example, the recruiter may include links to games 114(g) and commentary regarding the games 114(g). Other users may then navigate to this webpage 226 to learn about the recruiters impression of particular games (e.g., read a review of the game) and purchase the games through links included on the page. A variety of other examples or recruitment utilities are also contemplated, further discussion of which may be found in relation to FIGS. 7-14.

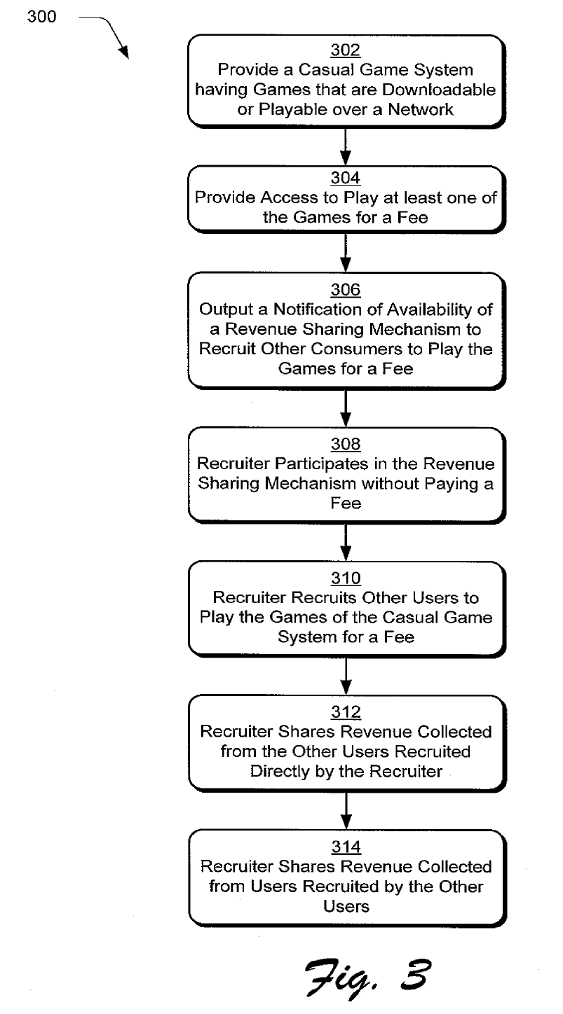

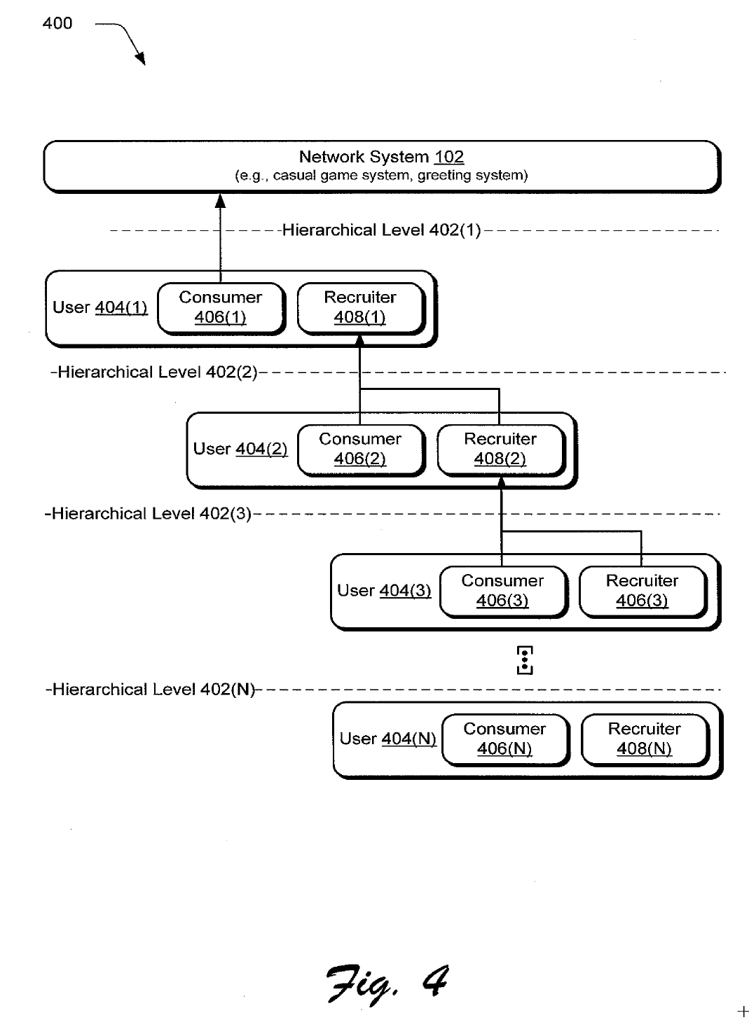

Revenue collected from the recruitment of users may then be shared with recruiter according to a recruiter hierarchy 228 having a plurality of levels 230(e), where “e” can be any integer from two to “E”. Levels 230(e) of the recruitment hierarchy 228 are defined according to a recruiter/recruit relationship. Therefore, each successive level specifies a recruit, which may be a recruit of a recruit. Revenue tracked by the revenue tracking module 210 may be shared with recruiters of the users that provided the revenue according to the recruiter hierarchy 228, further discussion of which may be found in relation to FIGS. 3 and 4.

Exemplary Procedures

The following discussion describes marketing techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to systems and components shown in FIGS. 1 and 2.

FIG. 3 depicts a procedure 300 in an exemplary implementation in which revenue, collected from recruits to play games, is shared with one or more recruiters. Although this example is described in the context of casual computer games, it should be understood that the same operations may be implemented by a marketing network attempting to market electronic greetings.

At block 302, a casual game system is provided having games that are downloadable or playable over a network. For example, the service system 102 may be configured to provide games 114(g) that are accessible by the client device 104(n) over the network 106. The games 114(g) may be configured in a variety of ways, such as for download of the games 114(g) over the network for local execution on the client device 104(n), for remote execution by the service system 102 as a browser-based game, and so on.

Access to one or more of the games 114(g) may be provided for a fee (block 304). For example, the fee may be transaction based such that access is provided on a per-transaction basis. The transactions, for instance, may be set per downloadable game such that each download is provided for a fee with unlimited access then provided to the downloaded game. The transaction may be limited to a particular period of time (e.g., a rental), such that a user may access the game for the particular period of time for a particular fee. In another example, the fee may be subscription based. The user, for instance, may pay a set fee for unlimited access to games for a particular amount of time, for a particular subset of games for a particular amount of time, and so on. A variety of other examples are also contemplated.

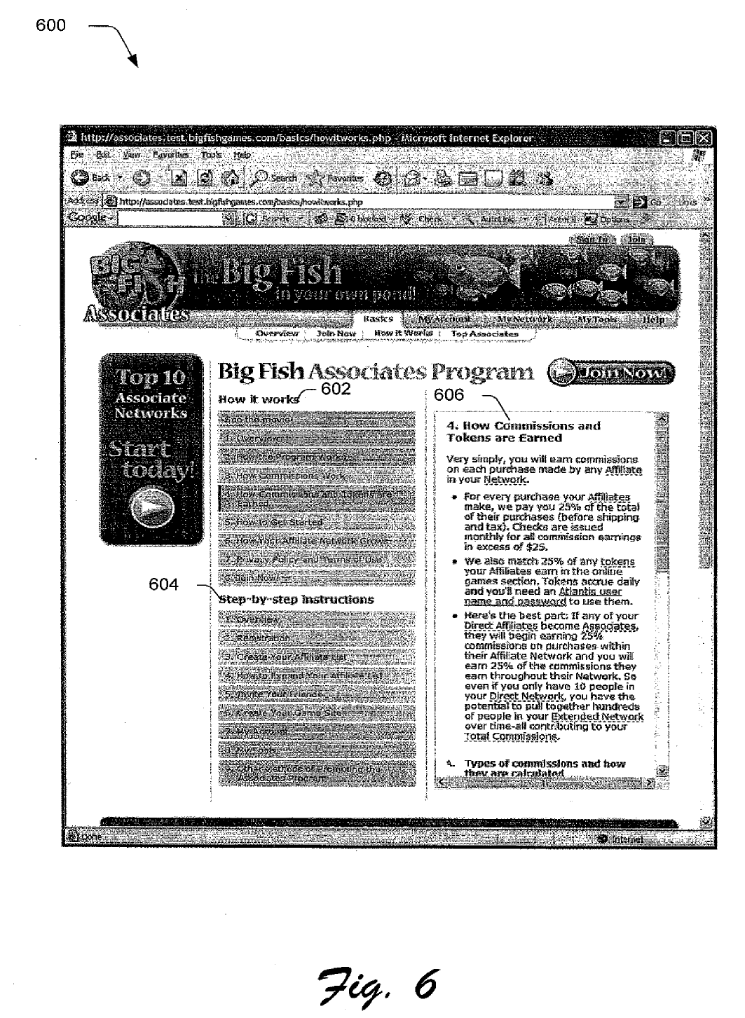

A notification is output as to the availability of a revenue sharing mechanism to recruit other consumer to play the games for a fee (block 306). While the user is playing games of the service system 102, for instance, an advertisement may be posted indicating that revenue collected from other users that are recruited by the user may be shared with the user. The advertisement, for instance, may be downloaded as part of the games 114(g), provided in the user interface 208(n) when interacting with the service system 102, retrieved from the service system 102 during local execution of the games 114(g), output during execution of games 114(g) remotely by the service system 102, and so on. The advertisement may also include a link to additional web pages that include detailed information regarding the revenue-sharing mechanism, further discussion of which may be found in relation to FIGS. 5 and 6.

The recruiter participates in the revenue sharing mechanism without paying a fee (block 308). For example, the recruiter may sign-up with the service system 102 to join a network of recruiters that recruit other potential users without providing an initial start up fee or any ongoing payment to the service system 102 to perform the recruiting. Further, the recruiter need not carry any inventory or make any kinds of purchases. The recruiter may optionally play games 114(g) of the service 102 for a fee, but that is unrelated to the recruiting. Therefore, in an implementation the recruiter may recruit other users without playing the games and therefore without providing any form of payment whatsoever to the service system 102. A variety of other implementations are also contemplated.

The recruiter recruits other users to play the games of the casual game system for a fee (block 310). For example, the recruiter may invite the other users to play the games 114(g) (e.g., via email, text message, instant message, and so on) and the other users may then play games 114(g) for a fee as previously described.

The recruiter may then share in the revenue collected from the other users that were recruited directly by the recruiter (block 312). The other users, for instance, may have had direct contact with recruitment materials of the recruiter (e.g., emails, adds, webpages, communications, and so on), were specified by the recruiter in a list 218 of recruits, and so on. Therefore, these other users in this example interact with the games 114(g) through direct efforts taken on by the recruiter and the recruiter shares revenue directly resulting from these efforts. In one implementation, the recruits have a limited time period after contact from the recruiter to play or purchase a game. One suitable time period is 60 days or less, although other time periods may be used.

The recruiter may also share revenue collected from users recruited by the other users (block 314), i.e., the direct recruits. The recruits (i.e., the other users) recruited by the recruiter, for instance, may also recruit users to pay fees to play the games 114(g) and share in the fees. In other words, the recruits may also act as recruiters. These fees may also “percolate up” to recruiters that recruited these recruiters through a hierarchy. In this way, the recruiter that recruited another recruiter may also share in fees collected from “indirect” recruits, further discussion of which may be found in relation to the following figure. Although the procedure 300 of FIG. 3 was described in relation to games 114(g), it should be readily apparent that similar functionality may also be employed for greetings 112(c), e.g., electronic greeting cards.

FIG. 4 illustrates an exemplary implementation of a hierarchy 400 having a plurality of hierarchical levels 402(1), 402(2), 402(3), . . . , 402(N). Each of the hierarchical levels 402(1)-402(N) is illustrated as having a respective user 404(1)-404(N). As illustrated, each of the users 404(1)404(N) may have different roles of consumer 406(1)-406(N) and recruiter 408(1) with respect to the service system 102.

User 404(1), for example, may be a consumer 406(1) with respect to the service system 102 by providing fees to play games 114(g) or send greetings 112(c) offered by the service system 102. The user 404(1) may also be a recruiter 408(1) in relation to user 404(2), which is illustrated as disposed in an adjacent hierarchical level 402(2). In other words, user 404(1) directly recruits 404(2) to interact with the service system 102. Therefore, the user 404(1) may share in revenue obtained by the user 404(2) when acting as a consumer 406(2) of network services of the service system 102.

The user 404(1) may also share in revenue received by user 404(2) for recruiting user 404(3). For example, user 404(2) may also act as a recruiter 408(2) to recruit user 404(3) and share in revenue collected from user 404(3) to interact with network services of the service system 102. Therefore, user 404(2) recruits user 404(3) directly to the service system 102. User 404(3) may also be considered to be indirectly recruited by user 404(1) through recruitment by at least one intervening user (e.g., user 404(2)) that was recruited by the user 404(1).

The hierarchy 400 may continue to include user 404(N) at hierarchical level 402(N). Therefore, the users recruited indirectly by the user 404(1) may continue to expand through efforts of direct and indirect recruits to recruit additional users and thus add levels and users to the hierarchy 400. Accordingly, revenue shared with the users 404(1)-404(N) may also continue to expand through vertical expansion (e.g., adding levels) as well as horizontal expansion (e.g., adding users to one or more of the levels) of the hierarchy 400.

FIG. 5 depicts a procedure 500 in an exemplary implementation in which a consumer interacts with a utility provided by a network service to recruit other consumers. During the discussion of FIG. 5, reference is also made to FIGS. 1, 2 and 4 as well as exemplary user interfaces 600-1400 of respective FIGS. 6-14. Further, although this example is described in the context of electronic greetings, it is noted that the same operations may be implemented by a marketing network attempting to market online games.

At block 502, a consumer sends a greeting available from a service system for a fee. A user of client device 104(1), for instance, may subscribe to the service system 102 to send greetings 112(c), such as to a user of client device 104(N). In another instance, the user may pay on a per-transaction basis to send greetings.

The consumer signs up, free of charge, to recruit other consumers to send greetings (block 504). The consumer, for instance, may interact with a user interface (UI) 600 of FIG. 6 that includes a description 602 of how revenue is to be shared as well as including step-by-step instructions 604 of how to register with the recruiting system (e.g., by supplying a user name and password to create an account) and manage recruits.

The UI 600 in this instance also includes a description 606 of how commissions and tokens are earned. The description specifies that for each purchase made by a recruit (e.g., labeled as an affiliate in the user interface 600), a specified percent of their total purchases (e.g., 25%) are shared with the recruiter. Tokens earned by the recruits are also shared, which in this instance are in addition to tokens earned by the recruits and thus does not affect the recruit, e.g., whether the recruit “signed-up” with the network service with or without being recruited by another user. Further, the description 606 specifies that revenue is also shared by recruits of the user's recruits, and so on as described in relation to FIG. 4.

Therefore, the revenue may be distributed according to a hierarchy (e.g., recruiter hierarchy 228) having a plurality of levels (e.g., levels 230(e)) that define a recruit/recruiter relationship. For instance, the recruiter may share revenue collected from recruits in the hierarchy based at least in part on an expression “Xⁿ”, where “n” denotes a difference in the levels in the hierarchy, at which, the recruiter and the recruit are respectively positioned and “X” denotes a predetermined percentage. For example, user 404(1) and user 404(3) are positioned at first and third levels 402(1), 402(3), respectively, and therefore a difference in the levels is two. Accordingly, assuming a predetermined percentage of 25%, user 404(1) would collect 6.25% of the revenue collected from user 404(3) and user 404(2) would collect 25% of the revenue. Naturally, this calculation may continue past hierarchical level 402(3) through hierarchical level 402(N). A variety of other examples are also contemplated.

At block 506, the consumer may optionally interact with a utility provided by the service system to recruit other consumers. The consumer, for instance, may add recruits to a list (block 508) such that when the recruits interact with the service system 102, e.g., to play a game 114(g) or send a greeting 112(c), revenue collected from the recruits is earmarked for the recruiter.

FIG. 7 shows an example UI 700 configured to form such a list. In UI 700, a plurality of text-entry portions are provided, in which, the consumer may specify email addresses of other users that are being recruited. Therefore, when the recruit accesses the network service 102, fees collected from the recruit are shared with the recruiter. In an implementation, the recruits included in the list are maintained for a limited period of time such that if the recruit does not pay a fee to and/or interact with the service system 102, the recruit is “freed up” to be recruited by another recruiter. As one example, the time period is set not to exceed 60 days.

The UI 700 also includes functionality 704 to download email addresses automatically. For example, the recruitment utility 212 may be executed to automatically download a contacts list 220(n) of the client device 104(n) such that the user of the client device 104(n) is freed from manual entry of each email address. In another example, the email list may be submitted as a plaintext list. A variety of other examples are also contemplated.

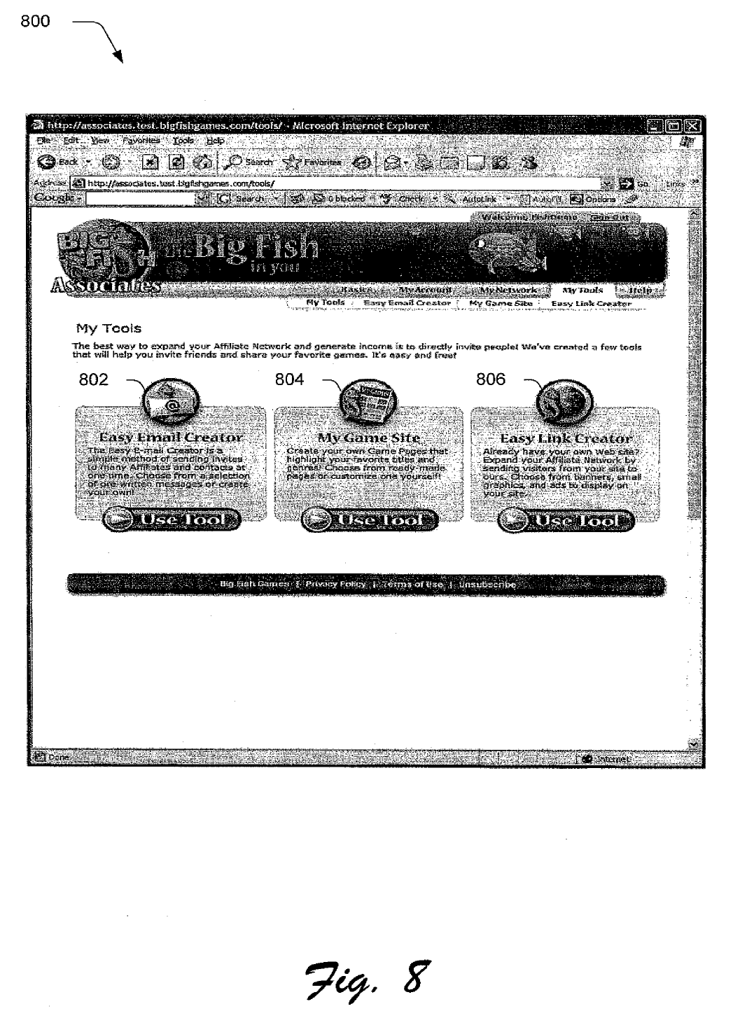

FIG. 8 illustrates an exemplary implementation of a user interface 800 in which a user may select among different utilities that may be employed to recruit other users. For example, the user may select from an email creator 802, a personalized web page creator 804 illustrated as “My Game Site” in FIG. 8 and a link creator 806, further discussion of each may be found in relation to the following examples.

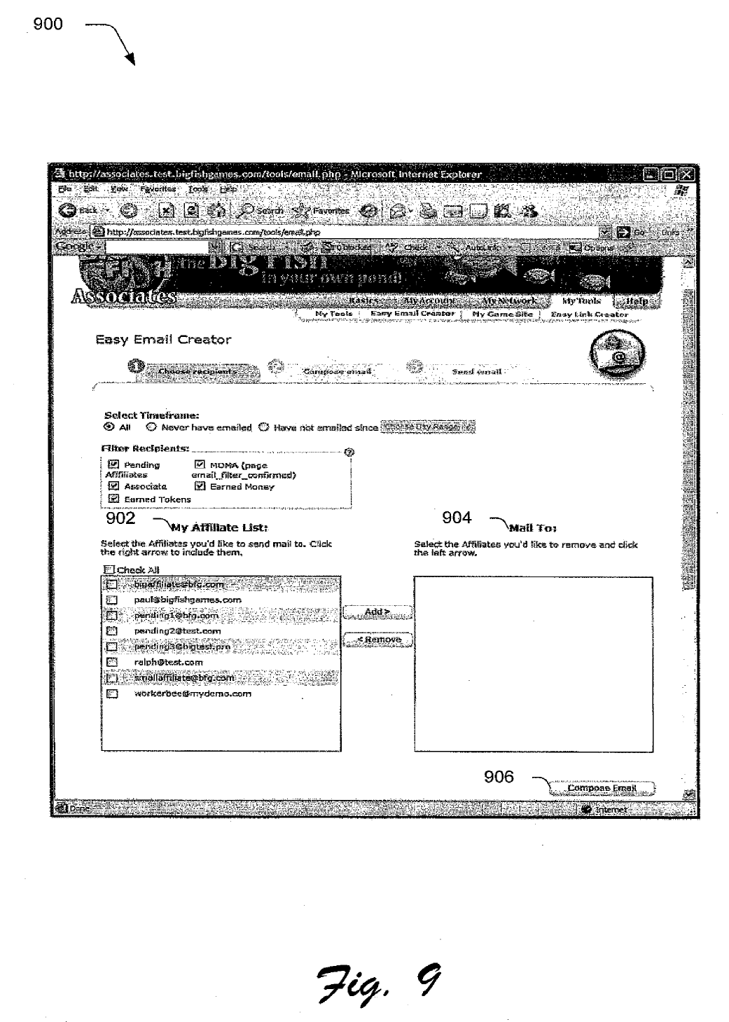

The user, for example, may interact with the email creator utility to create a preconfigured email to send to the other consumers (block 510 in FIG. 5). As shown in FIG. 9, for instance, an exemplary user interface 900 is shown in which a list 902 (which may be the same as or different from list 218) is used to specify which recruits are to receive emails. By selecting from the list 902 of recruits, the recruits may be added to a “Mail To:” portion 904 of the user interface. Once recruits are selected, the consumer may select a compose email 906 button to compose email for each of the selected recruits.

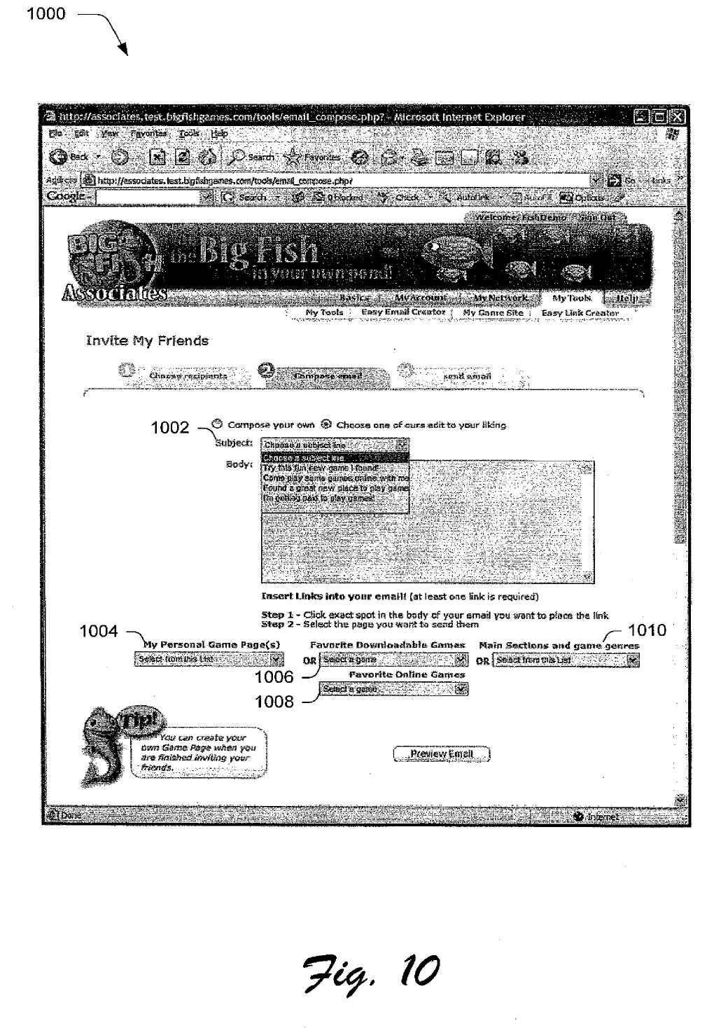

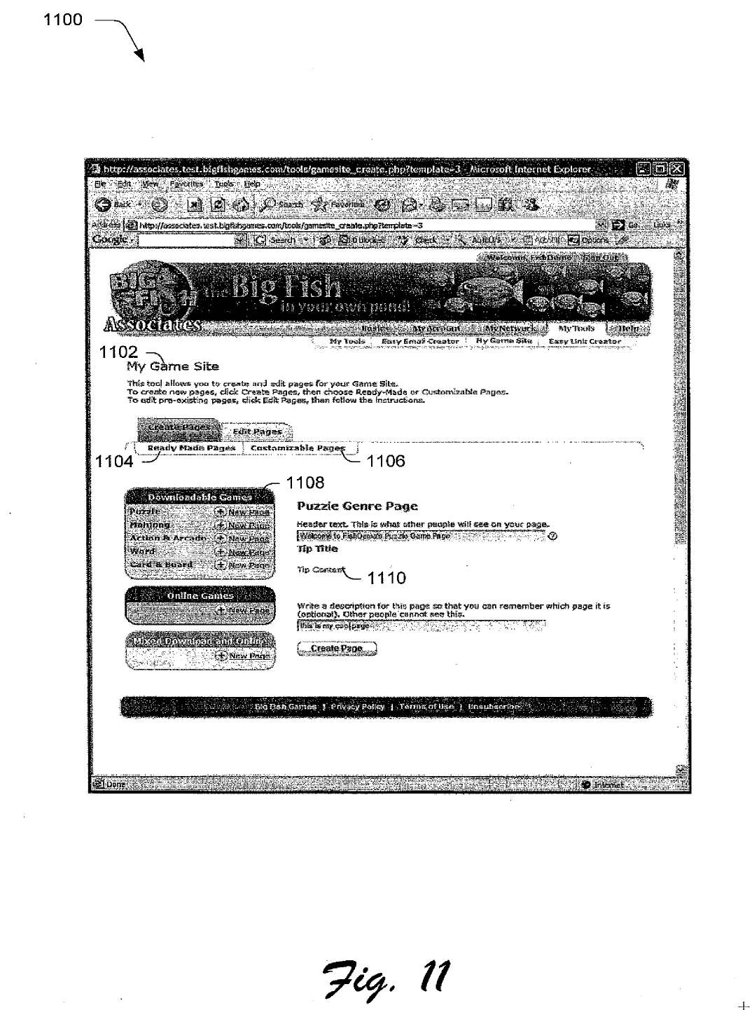

Once selected, the user interface 900 transitions to the user interface 1000 of FIG. 10, in which, the user may select a preconfigured email. The consumer, for instance, may select from a plurality of preconfigured subject lines 1002 for inclusion in the email. The consumer may also include a variety of other content for inclusion in the email. For example, the consumer may decide to include a link 1004 to a personal game page, creation of which will be further discussed in relation to FIG. 11. The consumer may also select links to favorite downloadable games 1006, links to favorite online games 1008, and/or links to main sections and game genres 1010. In an implementation, the consumer is permitted to add text to the body of the email that is not preconfigured, such as a personal review of the games referenced by the links 1006, 1008. In another implementation, the consumer is restricted from adding text other than a name to restrict use of possibly disparaging content through the service system 102. A variety of other implementations are also contemplated.

Reference will now be made again to FIG. 5, in another example the consumer interacts directly with a personalized web page creator to create a web page having games selected by the consumer and commentary regarding the games (block 512). The consumer, for instance, may interact with the user interface 1100 of FIG. 11 to create a personal game site 1102 from ready-made 1104 or customizable 1106 web pages. The consumer may select links 1108 to games to be included in the page, as well as supply commentary, such as tips 1110 to play the games, reviews of the games, and so on.

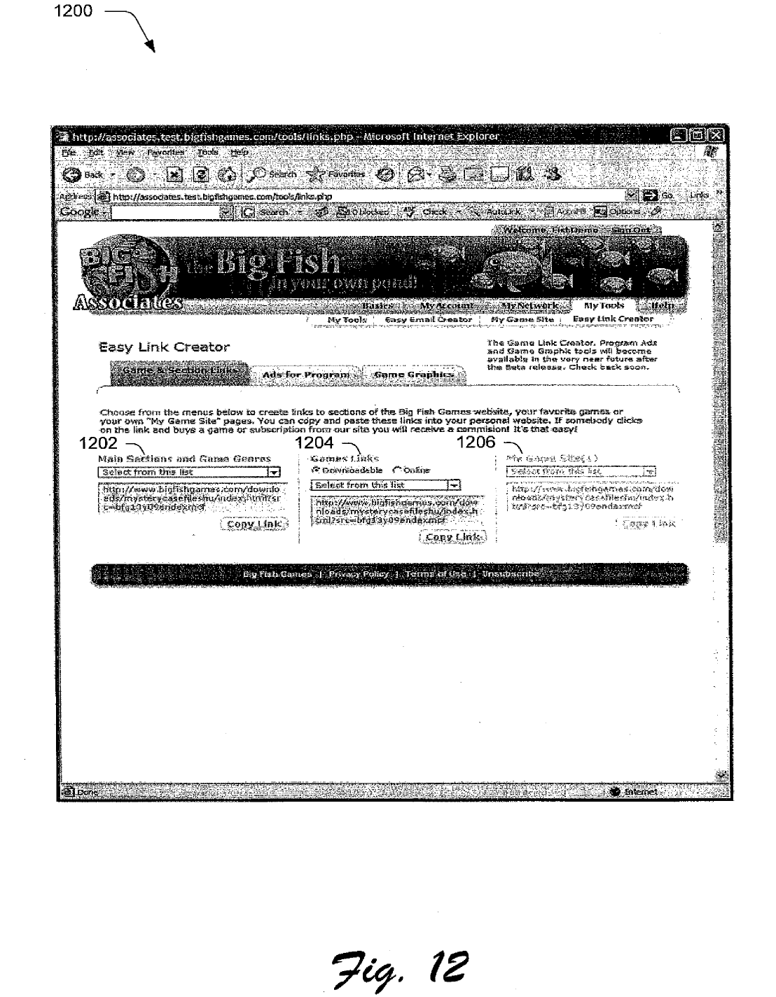

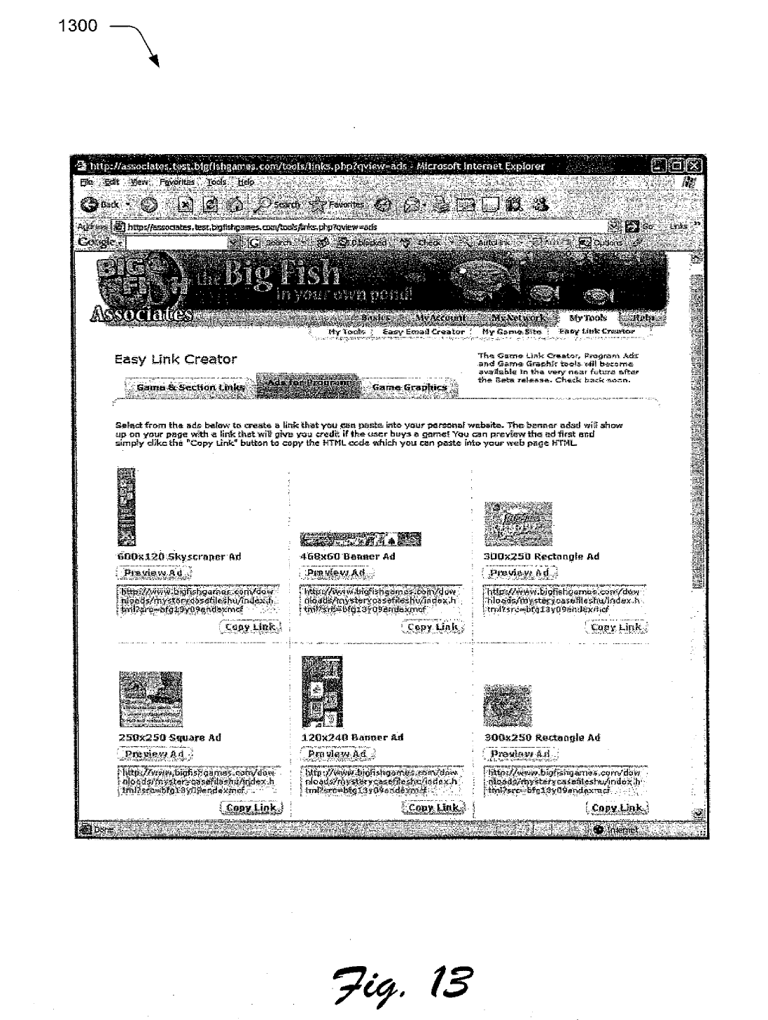

The consumer may also interact with a link creator utility to create a link (block 514). For example, the user may interact with the user interface 1200 of FIG. 12 to create links to main sections of games 1202, games 1204 themselves, and/or a game site 1206. In another example, the consumer may interact with the user interface 1300 of FIG. 13 to create advertisements for inclusion in web pages that are modifiable by the consumer. For example, the consumer may select from the plurality of ads and copy hypertext markup language (HTML) code to a described web page. The ad may be configured to include a link to the service system 102 that, when selected, automatically credits the consumer when the other users use the link to buy a game, greeting, and so on. In this way, the ads may be used by the consumer to recruit other users. Although a variety of utilities were described that were provided by the service system to users to recruit other users, a variety of other utilities are also contemplated without departing from the spirit and scope thereof.

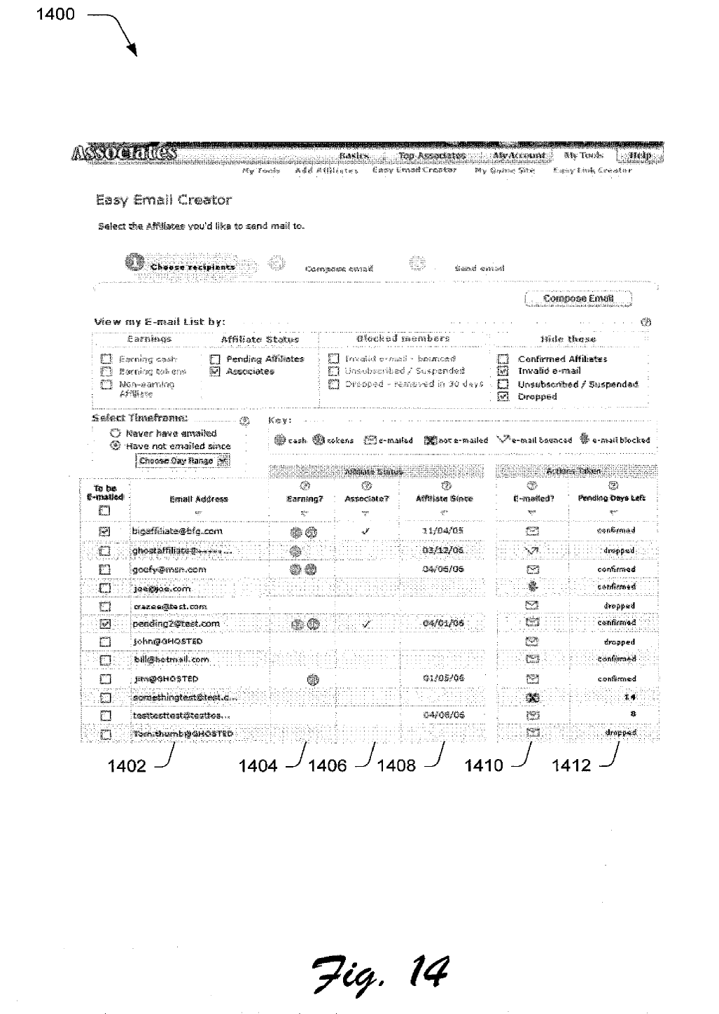

The user may also interact with the user interface to monitor the other consumers' interaction with the service system (block 516) as well as monitor revenue shared from the other consumers (block 518). For example, the user interface 1400 of FIG. 14 is illustrated similar to the user interface 900 of FIG. 9 in that it may be used to create emails to be sent to recruits. The user interface 1400, for instance, includes a list 1402 of email addresses specified by the consumer as recruits. The user interface 1400 also includes columns indicating whether the consumer is sharing revenue from the recruits 1404, when the recruit has recruited other recruits 1406, how long the recruit has been recruited 1408, whether an email was sent to the recruit 1410, and how many days are left in the predetermined period 1412 for the recruit to join the service system 102 (e.g., pay a fee for a network service, create an account, interact with a network service, and so on) before the recruit will be automatically removed. In this way, the consumer may be readily informed as to a variety of factors relating to other users recruited by the consumer. Naturally, a variety of other implementations are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
obtaining revenue with a service system resulting from consumers sending information and a link pertaining to electronic products via a website to other consumers and the other consumers using the link delivered with the information to purchase the electronic product; and
determining with the service system, for each of the consumers, whether the consumer was recruited by another one of the consumers, and if so, sharing revenue obtained with the service system with the recruiting consumer resulting from the other consumer purchasing the electronic product by using the link.

2. A method as recited in claim 1, wherein at least one of the greetings is customizable by the recruiting consumer.

3. A method as recited in claim 2, wherein the customization includes addition of a photo by the recruiting consumer.

4. A method as recited in claim 1, wherein the electronic product is a casual game, wherein the information includes a list of casual games available for download and purchase, wherein the link is embedded in the information, and wherein the information is provided from a website controlled by the recruiting consumer.

5. A method as recited in claim 1, wherein the obtained revenue is transaction based.

6. A method as recited in claim 1, wherein the obtained revenue is monetary based.

7. A method as recited in claim 1, further comprising sharing the obtained revenue with yet another consumer that recruited the other consumer.

8. One or more computer-readable memories comprising computer-executable instructions that, when executed, perform acts comprising:
presenting a user interface that allows a consumer to join, free of charge, a network of recruiters;
enabling the consumer, via the user interface, to specify a list of users to send from a system via a network information comprising links to available electronic products; and
allocating to the consumer a portion of the revenue collected from the users who purchase the electronic products obtained using the links.

9. One or more computer-readable memories as recited in claim 8, wherein at least one of the electronic products is an electronic greeting card to be communicated over a network.

10. One or more computer-readable memories as recited in claim 8, wherein the allocating is performed according to a hierarchy having a plurality of levels that define a recruit/recruiter relationship; and
the recruiter shares revenue collected from recruits in the hierarchy based at least in part on an expression “Xⁿ”, where “n” denotes a difference in the levels in the hierarchy, at which, the recruiter and the recruit are respectively positioned and “X” denotes a percentage.

11. One or more computer-readable memories as recited in claim 8, wherein users are removed from the list when the users have not purchased electronic products for a predetermined period of time.

12. One or more computer-readable memories as recited in claim 8, wherein users are removed from the list when the users have not accessed the system for a predetermined period of time.

13. One or more computer-readable memories as recited in claim 8, wherein the user interface specifies portions of revenue collected from each respective user.

14. One or more computer-readable memories as recited in claim 8, wherein the user interface specifies revenue collected from each respective consumer based on purchases obtained using the links from the users.

15. An apparatus comprising:
a processor; and
a memory configured to maintain one or more electronic products to be communicated over a network to one or more users and a module that is executable on the processor to:
receive inputs sent via a network to join a network of recruiters, free of cost, that recruit consumers to electronically solicit the one or more users to purchase the one or more electronic products by transmitting to the users a list of available electronic products for download and purchase; and
share a portion of revenue collected from users that purchased the electronic products from the list with the recruited consumers that solicited the users to purchase the electronic products.

16. An apparatus as recited in claim 15, wherein the revenue is generated from subscription sales of the electronic products.

17. An apparatus as recited in claim 15, wherein the revenue is generated when the user purchases an electronic product, and wherein the electronic product is a casual computer game.

18. An apparatus as recited in claim 15, wherein the inputs to join the network of recruiters specify a consumer name, password and mailing address of a consumer that is to recruit the users.

19. An apparatus as recited in claim 15, wherein the module is further executable to provide one or more utilities that are accessible over the network to recruit the consumers.

20. An apparatus as recited in claim 15, wherein the portion of revenue is shared according to a hierarchy, such that, consumers receive revenue from the recruited consumers to send the electronic products as well as revenue received by the recruited consumers to recruit other consumers.

21. An apparatus as recited in claim 15, wherein:
the revenue is distributed according to a hierarchy having a plurality of levels that define a recruit/recruiter relationship; and
the recruiter shares revenue collected from recruits in the hierarchy based at least in part on an expression “Xⁿ”, where “n” denotes a difference in the levels in the hierarchy, at which, the recruiter and the recruit are respectively positioned and “X” denotes a percentage.
